(19) United States
(12) Patent Application Publication
(10) Pub. No.: US 2026/0304061 A1
(43) Pub. Date: Oct. 1, 2026

(54) ELECTRONIC DEVICE FOR GENERATING BINAURAL IMPULSE RESPONSE AND OPERATION METHOD OF THE SAME

(71) Applicant: Electronics and Telecommunications Research Institute, Daejeon (KR)

(72) Inventors: Young Ho JEONG, Daejeon (KR); Kyeongok KANG, Daejeon (KR); Jae-hyoun YOO, Daejeon (KR); Yong Ju LEE, Daejeon (KR); Dae Young JANG, Daejeon (KR); Jung Won KANG, Daejeon (KR); Seung Kwon BEACK, Daejeon (KR); Tae Jin LEE, Daejeon (KR)

(73) Assignee: Electronics and Telecommunications Research Institute, Daejeon (KR)

(21) Appl. No.: 19/634,216

(22) Filed: Mar. 31, 2026

(30) Foreign Application Priority Data
Apr. 1, 2025 (KR) 10-2025-0042091

(51) Int. Cl. H04S 7/00

(52) U.S. Cl. CPC H04S 7/304; H04S 2400/11; H04S 2400/13; H04S 2420/01

(57) ABSTRACT

An electronic device for generating a binaural impulse response (BIR) and an operation method of the electronic device are provided. The operation method of the electronic device includes generating a mesh latent vector based on three-dimensional (3D) mesh data for a virtual space that provides spatial audio to a listener, inputting, to an artificial intelligence (AI) model, the mesh latent vector and conditional information including directional information of a sound source based on a head position of the listener, and generating the spatial audio based on a BIR obtained from the AI model.

### CROSS-REFERENCE TO RELATED APPLICATION

This application claims the benefit of Korean Patent Application No. 10-2025-0042091, filed on Apr. 1, 2025, in the Korean Intellectual Property Office (now the Ministry of Intellectual Property (MOIP)), the entire disclosure of which is incorporated herein by reference for all purposes.

### BACKGROUND

### 1. Field of the Invention

One or more embodiments relate to an electronic device for generating a binaural impulse response (BIR) and an operation method of the electronic device.

### 2. Description of the Related Art

In virtual spaces such as a metaverse or games, real-time rendering of binaural spatial audio that changes according to the head movements of a user wearing a head-mounted display (HMD) is essential to enhance user immersion.

Recently, artificial intelligence (AI) has attracted attention for demonstrating innovative content generation capabilities in various applications, including text, images, speech, and video. In particular, advancements in natural language processing (NLP) and image generation technologies have enabled more precise understanding of user intent and the generation of richer responses.

Based on these technological innovations, research has been conducted to utilize AI for the generation of binaural spatial audio.

### SUMMARY

Embodiments provide an electronic device and a method of generating a binaural impulse response (BIR) using an artificial intelligence (AI) model trained to learn directional information of a sound source based on the head position of a user.

Embodiments provide a method of generating training data for training an AI model that generates a BIR.

Embodiments provide an electronic device and a method of training an AI model that generates a BIR.

According to an aspect, there is provided an operation method of an electronic device including generating a mesh latent vector based on three-dimensional (3D) mesh data for a virtual space that provides spatial audio to a listener, inputting, to AI model, the mesh latent vector and conditional information including directional information of a sound source based on a head position of the listener, and generating the spatial audio based on a BIR obtained from the AI model.

The conditional information may include first position information of the sound source in the virtual space and second position information of the listener in the virtual space, and the directional information may include azimuth information of the sound source based on the head position of the listener and elevation angle information of the sound source based on the head position of the listener.

The AI model may be trained to output the BIR reflecting an effect in which a sound level heard by a left ear and a right ear varies according to a change in a direction in which a head of the listener is oriented.

The operation method may further include generating the directional information of the sound source based on head rotation information representing a degree of rotation of a head of the listener.

The generating of the directional information may include determining a rotation matrix based on the head rotation information, determining position coordinates of the sound source with a position of the listener as an origin, and determining the directional information based on the rotation matrix and the position coordinates.

The operation method may further include determining the directional information based on third position information of a point viewed by the listener.

The determining of the directional information based on the third position information may include determining a unit vector from the listener toward the point based on first position information of the listener included in the conditional information and the third position information, based on the unit vector, resetting a reference coordinate system to a coordinate system in which the listener views the point, transforming second position information of the sound source based on the coordinate system, and determining the directional information based on the transformed second position information.

A non-transitory computer-readable storage medium storing one or more computer programs including instructions for performing one of the operations described above.

According to another aspect, there is provided an operation method of an electronic device including, based on input data, generating first position information of a sound source in a virtual space in which the sound source is to be played, second position information of a listener in the virtual space, and 3D mesh data for the virtual space, generating a mono IR based on the first position information of the sound source, the second position information of the listener, and the 3D mesh data, and generating a plurality of ground-truth BIRs, based on the mono IR and a plurality of pieces of directional information representing directional information of the sound source based on a head position of the listener.

The operation method may further include, based on the plurality of ground-truth BIRs, training an AI model to output a target BIR when the AI model receives a target mesh latent vector of a target virtual space in which a target sound source is to be played, a target position of a target listener, a target position of the target sound source, and target directional information of the target sound source based on a head position of the target listener.

The AI model may be trained to minimize a loss function including a first loss related to quality of an output of the AI model, a second loss related to a relative change between a channel corresponding to a left ear and a channel corresponding to a right ear in the output, a third loss related to energy decay and a fourth loss related to a reverberation time required for reverberation of a sub-band to decay by a predetermined number of decibels, and wherein the first loss, the second loss, the third loss, and the fourth loss may be determined based on the target BIR and the plurality of ground-truth BIRs.

According to another aspect, there is provided an electronic device including a processor configured to generate a mesh latent vector based on 3D mesh data for a virtual space that provides spatial audio to a listener, input, to an AI model, the mesh latent vector and conditional information including directional information of a sound source based on a head position of the listener, and generate the spatial audio based on a BIR obtained from the AI model.

The conditional information may include first position information of the sound source in the virtual space and second position information of the listener in the virtual space, and the directional information may include azimuth information of the sound source based on the head position of the listener and elevation angle information of the sound source based on the head position of the listener.

The AI model may be trained to output the BIR reflecting an effect in which a sound level heard by a left ear and a right ear varies according to a change in a direction in which a head of the listener is oriented.

The processor may be configured to generate the directional information of the sound source based on head rotation information representing a degree of rotation of a head of the listener.

The processor may be configured to determine a rotation matrix based on the head rotation information, determine position coordinates of the sound source with a position of the listener as an origin, and determine the directional information based on the rotation matrix and the position coordinates.

The processor may be configured to determine the directional information based on third position information of a point viewed by the listener.

The processor may be configured to determine a unit vector from the listener toward the point based on first position information of the listener included in the conditional information and the third position information, reset, based on the unit vector, a reference coordinate system to a coordinate system in which the listener views the point, transform second position information of the sound source based on the coordinate system, and determine the directional information based on the transformed second position information.

Additional aspects of embodiments will be set forth in part in the description which follows and, in part, will be apparent from the description, or may be learned by practice of the disclosure.

According to embodiments, it may be possible to generate a BIR using an AI model that learns directional information of a sound source based on the head position of a user.

According to embodiments, it may be possible to generate training data for training an AI model that learns directional information of a sound source based on the head position of a user.

According to embodiments, it may be possible to generate an AI model that learns directional information of a sound source based on the head position of a user.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an electronic device according to an embodiment;

FIG. 2 is a diagram illustrating a method of generating spatial audio according to an embodiment;

FIG. 3 is a diagram illustrating an artificial intelligence (AI) model and training of the AI model, according to an embodiment;

FIG. 4 is a flowchart illustrating an operation of an electronic device according to an embodiment;

FIG. 5 is a block diagram illustrating generation of training data for training an AI model, according to an embodiment;

FIG. 6 is a diagram illustrating generation of a plurality of pieces of head rotation information, according to an embodiment; and

FIG. 7 is a diagram illustrating spatial audio according to an embodiment.

### DETAILED DESCRIPTION

Hereinafter, embodiments are described in detail with reference to the accompanying drawings. The scope of the right, however, should not be construed as limited by the embodiments set forth herein. In the drawings, like reference numerals are used for like elements.

Various modifications may be made to the embodiments. Here, the embodiments are not to be construed as limited by the disclosure and should be construed as including all changes, equivalents, and replacements within the idea and the technical scope of the disclosure.

Although terms such as “first” or “second” are used to explain various components, the components are not limited to the terms. These terms should be used only to distinguish one component from another component. For example, a first component may be referred to as a second component, or similarly, the second component may be referred to as the first component.

The terminology used herein is for the purpose of describing particular embodiments only and is not intended to limit the embodiments. As used herein, the singular forms “a,” “an,” and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, when describing the examples with reference to the accompanying drawings, like reference numerals refer to like elements, and a repeated description related thereto is omitted. In the description of embodiments, detailed description of well-known related technology will be omitted when it is deemed that such description will cause ambiguous interpretation of the disclosure.

Hereinafter, embodiments are described in detail with reference to the accompanying drawings.

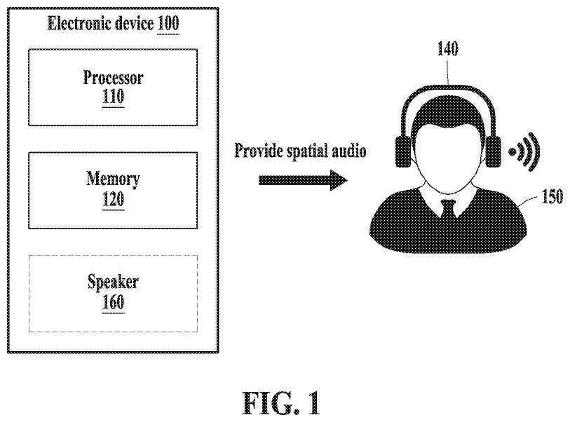

FIG. 1 is a diagram illustrating an electronic device according to an embodiment.

FIG. 1 illustrates an electronic device 100 including a processor 110 and memory 120. The processor 110 and the memory 120 may communicate with each other through an interface such as a system bus, peripheral component interconnect (PCI), and peripheral component interconnect express (PCIe). FIG. 1 illustrates only components that may be used in the disclosure. Thus, it is obvious to those skilled in the art that the electronic device 100 may also include other components in addition to the components illustrated in FIG. 1.

The processor 110 may perform overall functions for controlling the electronic device 100. The processor 110 may generally control the electronic device 100 by executing programs and/or instructions stored in the memory 120. The processor 110 may be implemented as a central processing unit (CPU), a graphics processing unit (GPU), an application processor (AP), and the like, which are included in the electronic device 100. However, embodiments are not limited thereto.

The memory 120 may be hardware for storing data processed in the electronic device 100 and data to be processed. In addition, the memory 120 may store an application, a driver, and the like to be driven by the electronic device 100. The memory 120 may include volatile memory, such as dynamic random-access memory (DRAM), and/or non-volatile memory.

The electronic device 100 may generate spatial audio and provide the spatial audio to a listener 150. The electronic device 100 may generate binaural spatial audio and provide the binaural spatial audio to the listener 150. The electronic device 100 may provide the listener 150 with binaural spatial audio generated based on a binaural impulse response (BIR). The binaural spatial audio may be vivid three-dimensional (3D) audio in which a BIR is convolved with an original sound in a space (e.g., a virtual space) that reflects the head orientation and ear shape of the listener 150, producing an effect similar to sound occurring in a real space. The binaural spatial audio may provide the listener 150 with a sense of immersion by rendering the audio so that the audio is perceived as originating from a predetermined direction. Spatial audio described herein may represent binaural spatial audio.

The electronic device 100 may generate binaural spatial audio based on an artificial intelligence (AI) model. The electronic device 100 may generate binaural spatial audio based on the AI model based on a deep neural network (DNN), a recurrent neural network (RNN), a graph neural network (GNN), and a convolutional neural network (CNN). The electronic device 100 may generate binaural spatial audio based on a generative AI model.

The electronic device 100 may provide the listener 150 with spatial audio through an external electronic device 140. For example, when the electronic device 100 is a personal computer (PC) and the external electronic device 140 is a device capable of outputting sound, such as a head mounted display (HMD) or Bluetooth earphones, the electronic device 100 may provide spatial audio through the external electronic device 140.

According to an embodiment, the electronic device 100 may further include a speaker 160. When the electronic device 100 further includes the speaker 160, the electronic device 100 may directly provide spatial audio to the listener 150. For example, when the electronic device 100 is an HMD, the electronic device 100 may further include the speaker 160 and provide spatial audio to the listener 150.

In order to provide a higher level of immersion to the listener 150 using binaural spatial audio, it may be necessary to accurately reproduce an interaural level difference (ILD) effect, in which the level of sound heard by the left and right ears varies depending on the change in the direction of the head of the listener 150. To accurately reproduce the ILD effect, additional directional information about a sound source relative to a head position may be required.

Hereinafter, a method of providing binaural spatial audio that may reproduce an accurate ILD effect using an AI model that learns directional information is described.

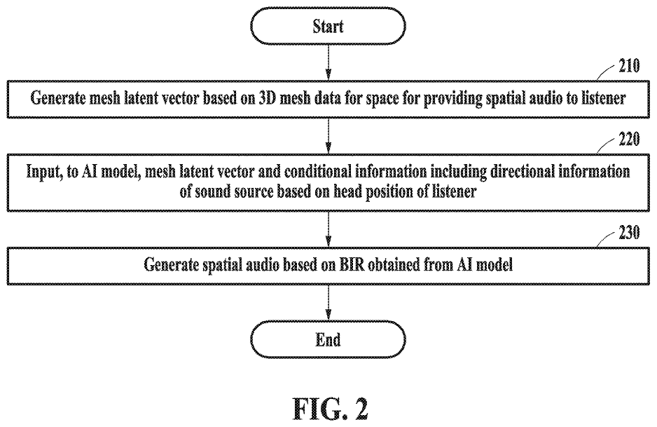

FIG. 2 is a diagram illustrating a method of generating spatial audio according to an embodiment.

Operations described with reference to FIG. 2 may be performed sequentially but not necessarily. For example, the order of the operations may be changed, and at least two of the operations may be performed in parallel.

In operation 210, an electronic device may generate a mesh latent vector based on 3D mesh data for a virtual space that provides spatial audio to a listener.

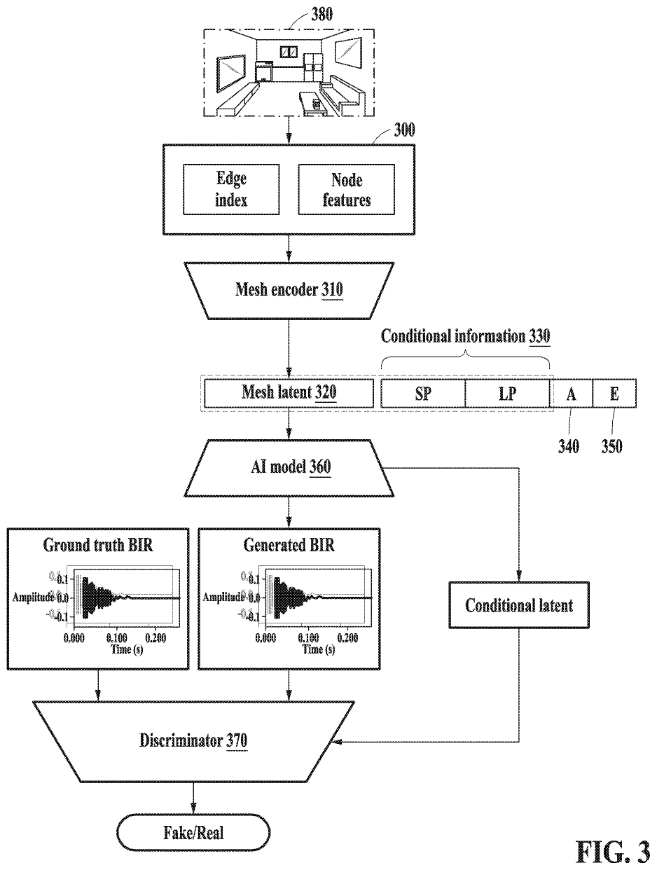

The 3D mesh data may be data that represents a virtual space. A method of generating a mesh latent vector is described below with reference to FIG. 3.

In operation 220, the electronic device may input, to an AI model, a mesh latent vector and conditional information including directional information of a sound source based on the head position of the listener.

The AI model may be an AI model trained to generate a BIR based on the mesh latent vector and the conditional information. The BIR may include a channel corresponding to the left ear and a channel corresponding to the right ear. For example, the AI model may be a generative AI model. An AI model is described below with reference to FIG. 3.

In operation 230, the electronic device may generate spatial audio based on a BIR obtained from the AI model.

The electronic device may generate spatial audio based on the binaural IR output from the AI model and the original sound of the sound source. The electronic device may generate binaural spatial audio by convolving the BIR with the original sound. The electronic device may provide spatial audio to the listener through speakers inside or outside the electronic device.

Hereinafter, an AI model is described.

FIG. 3 is a diagram illustrating an AI model and training of the AI model, according to an embodiment.

An electronic device may train an AI model (e.g., an AI model of FIG. 3) based on training data. The training data may include input data and a ground truth BIR (e.g., ground truth BIR of FIG. 3).

Based on the input data, the electronic device may generate 3D mesh data, first position information of a sound source (e.g., source position (SP) of FIG. 3), second position information of a listener (e.g., listener position (LP)), and directional information. The electronic device may parse the input data to generate the 3D mesh data, the first position information of the sound source, the second position information of the listener, and the directional information. The directional information may include azimuth information (e.g., A 340 in FIG. 3) of the sound source based on the head position of the listener and elevation angle information (e.g., E 350 in FIG. 3) of the sound source based on the head position of the listener.

3D mesh data 300 may be data representing a virtual space 380. The 3D mesh data 300 may include an edge index including connection information between nodes in the virtual space 380 and a node feature including 3D coordinates and acoustic properties (e.g., an absorption coefficient, a scattering coefficient, etc.) of nodes.

The electronic device may input the 3D mesh data 300 to a mesh encoder 310. The mesh encoder 310 may generate a mesh latent vector 320 based on the 3D mesh data 300. The mesh latent vector 320 may be an eight-dimensional reduced representation of the 3D mesh data 300. The first position information and the second position information may each be 3D coordinate information. Therefore, the mesh latent vector 320, the first position information, and the second position information may include a fourteen-dimensional vector.

An AI model 360 may generate a BIR (e.g., a generated BIR of FIG. 3) based on the mesh latent vector 320 and conditional information. The conditional information may include first position information of the sound source in the virtual space 380, second position information of the listener in the virtual space 380, and directional information.

The directional information may include azimuth information (A 340) of the sound source based on the head position of the listener in the virtual space 380 and elevation angle information (E 350) of the sound source based on the head position of the listener. A method of generating directional information is described below.

The AI model 360 may receive the mesh latent vector 320 and the conditional information. The AI model 360 may generate a BIR including a plurality of dimensions (e.g., a plurality of samples). For example, the AI model 360 may generate a BIR having a sampling frequency of 16 kilohertz (kHz) and including 4,096 samples.

Among the plurality of samples of the BIR, a plurality of first samples positioned at the back (e.g., 128 samples from the very back) may all have the same scaled standard deviation (SD) value of the BIR. The remaining second samples (e.g., 3,096 samples from the very front) among the plurality of samples may be BIRs normalized to scaled SD values.

A discriminator 370 may be trained to distinguish a BIR output by the AI model 360 as a fake signal and a ground truth BIR (e.g., the ground truth BIR of FIG. 3) as a real signal. The AI model 360 may be trained to output a BIR similar to the ground truth BIR based on a loss value obtained from the discriminator 370.

For example, the AI model 360 may be trained based on a conditional generative adversarial network (CGAN) structure connected to the discriminator 370 through a conditional latent vector.

Hereinafter, a method of determining directional information is described.

According to an embodiment, the electronic device may generate directional information of a sound source based on head rotation information indicating the degree to which the head of the listener is rotated. The first position information of the sound source in the virtual space 380 may be (SPₓ, SP_{y}, SP_{z}) The second position information of the listener in the virtual space 380 may be (LPₓ, LP_{y}, LP_{z}).

The head rotation information, which indicates the degree to which the head of the listener is rotated, may be determined based on yaw (φ), pitch (ϑ), roll (ρ), which are rotation angles about three axes (e.g., 3 degrees of freedom (3 DoF)) representing head rotation in a 3D space. The head rotation information, which indicates the degree to which R_{yaw}, R_{pitch}, Rᵣₒₗₗ, the head of the listener is rotated, may be determined as, as shown in Equation 1 below.

$${R}_{yaw} = [ \begin{matrix}cos φ & 0 & sin φ \\ 0 & 1 & 0 \\ - sin φ & 0 & cos φ\end{matrix} ] \qquad [ Equation 1 ]$$

$${R}_{pitch} = [ \begin{matrix}1 & 0 & 0 \\ 0 & cos ϑ & - sin ϑ \\ 0 & sin ϑ & cos ϑ\end{matrix} ]$$

$${R}_{roll} = [ \begin{matrix}cos ρ & - sin ρ & 0 \\ sin ρ & cos ρ & 0 \\ 0 & 0 & 1\end{matrix} ]$$

The electronic device may determine a rotation matrix based on the head rotation information. The electronic device may determine the rotation matrix R as shown in Equation 2 below.

$$R = {R}_{yaw} \cdot {R}_{pitch} \cdot {R}_{roll} \qquad [ Equation 2 ]$$

The electronic device may determine where the sound source is positioned relative to the position of the listener and the direction of the head of the listener. Based on Equation 3 below, the electronic device may determine the position coordinates \vec{d}_{LS} of the sound source with the second position information of the listener as an origin.

$${\vec{d}}_{LS} = [ \begin{matrix}{SP}_{x} - {LP}_{x} \\ {SP}_{y} - {LP}_{y} \\ {SP}_{z} - {LP}_{z}\end{matrix} ] \qquad [ Equation 3 ]$$

The electronic device may determine the position \vec{d′}_{LS}=(x′, y′, z′) of the sound source transformed in a reference coordinate system of the listener based on the rotation matrix R and the position coordinates \vec{d}_{LS} of the sound source having the second position information of the listener as the origin. The position of the sound source may be determined based on Equation 4 below.

$${\vec{{d}^{′}}}_{LS} = R \cdot {\vec{d}}_{LS} \qquad [ Equation 4 ]$$

The electronic device may determine the azimuth information (A 340) (e.g., φ) φ) and the elevation angle information (E 350) (e.g., θ), which are directional information, based on the position coordinates \vec{d}_{LS} of the sound source with the second position information of the listener as the origin. The electronic device may determine the azimuth information (A 340) based on Equation 5 below and may determine the elevation angle information (E 350) based on Equation 6 below.

$$ϕ = ar tan ( {y}^{′} , {x}^{′} ) \qquad [ Equation 5 ]$$

$$θ = arcsin ( \frac{{z}^{′}}{‖ {\vec{{d}^{′}}}_{LS} ‖} ) \qquad [ Equation 6 ]$$

∥\vec{d′}_{LS}∥ may be determined as \sqrt{(x′)²+(y′)²+(z′)²} with the size of \vec{d′}_{LS}.

According to an embodiment, instead of the head rotation information, third position information of a point viewed by the listener may be provided. The electronic device may determine directional information based on the third position information of the point viewed by the listener. For example, (TPₓ, TP_{y}, TP_{z}) which is the third position information of the point viewed by the listener, may be provided.

The electronic device may reset the reference coordinate system so that the listener views the point. The electronic device may reset the reference coordinate system by taking the position of the listener as the origin and setting the direction from the listener to the point as a reference axis Z′. The reference axis Z′ may be determined as a unit vector from the listener toward the point as shown in Equation 7.

$${Z}^{′} = \frac{( {TP}_{x} - {LP}_{x} , {TP}_{y} - {LP}_{y} , {TP}_{z} - {LP}_{z} )}{‖ TP - LP ‖} \qquad [ Equation 7 ]$$

In the reset reference coordinate system, the reference axis Y′ may be determined as a unit vector perpendicular to the reference axis as shown in Equation 8. Y_{world} may be (0, 1, 0), which is the Y-axis direction vector in the world coordinate system. In the reset reference coordinate system, X′ may be determined as shown in Equation 9.

$${Y}^{′} = \frac{{Y}_{world} \times {Z}^{′}}{‖ {Y}_{world} \times {Z}^{′} ‖} \qquad [ Equation 8 ]$$

$${X}^{′} = {Y}^{′} \times {Z}^{′} \qquad [ Equation 9 ]$$

The electronic device may determine the reset reference coordinate system (X′, Y′, Z′) in which the listener views the point. Based on Equation 10 below, the electronic device may determine the position of the sound source \vec{d′}_{LS}=(x′, y′, z′) transformed in the reset reference coordinate system.

$${\vec{{d}^{′}}}_{LS} = [ \begin{matrix}{X}^{′} \\ {Y}^{′} \\ {Z}^{′}\end{matrix} ] \cdot {\vec{d}}_{LS} \qquad [ Equation 10 ]$$

The electronic device may determine the azimuth information (A 340) (e.g., φ) and the elevation angle information (E 350) (e.g., θ), which are directional information, based on Equation 5 and Equation 6 \vec{d′}_{LS}=(x′, y′, z′) described above.

The electronic device may train an AI model to minimize a loss function. The loss function may be determined as shown in Equation 11 below. The loss function may include a plurality of loss terms (e.g., errors).

$${L}_{G} = {L}_{CGAN} + {λ}_{BIR} {L}_{BIR} + {λ}_{ED} {L}_{ED} + {λ}_{MSE} {L}_{MSE} + {λ}_{RT 20} {L}_{RT 20} \qquad [ Equation 11 ]$$

L_{CGAN} may be a CGAN error, L_{BIR} may be a BIR error, L_{ED} may be an energy decay error, L_{MSE} may be a mean squared error (MSE), and L_{RT20} may be a reverberation time error. λ_{BIR}, λ_{ED}, λ_{MSE}, and λ_{RT20} may be weights for the BIR error, the energy decay error, the MSE, and the reverberation time error, respectively.

L_{CGAN} may be a loss related to the quality of an output of the AI model 360. L_{CGAN} may be a CGAN error that improves the quality of a BIR generated by the AI model 360 so that the BIR output by the AI model 360 may be determined as a real signal by the discriminator 370. L_{BIR} may be a BIR error indicating a relative change between a channel corresponding to the left ear and a channel corresponding to the right ear. L_{ED} may be an energy decay error configured to simulate energy decay for each sub-band. L_{MSE} may be an MSE that helps capture the structure of a BIR.

L_{RT20} may be a reverberation time error based on a sub-band (RT20_{sub}) and may be determined as shown in Equation 12 below.

$${L}_{RT 20} = {𝔼}_{( {B}_{G} , {Γ}_{S} ) \sim {P}_{data}} [ \text{} {𝔼}_{c \sim C} [ \text{} 𝔼 [ \text{} ( RT 20 ( {B}_{G} ( {Γ}_{S} ) , c ) - RT 20 ( {B}_{N} ( {Γ}_{S} ) , c ) ) ] ] ] \qquad [ Equation 12 ]$$

B_{G} may represent a ground truth BIR. Γ_{S} may represent input information of the AI model 360 that includes a mesh latent vector. (B_{G}, Γ_{S})~P_{data} may indicate that a data sample (B_{G}, Γ_{S}) is extracted from a training dataset P_{data} that the AI model 360 desires to learn. c~C may indicate that sub-band c is extracted from sub-band set C. B_{G}(Γ_{S}) may represent the ground truth BIR for Γ_{S}. B_{N}(Γ_{S}) may represent a BIR, which is an output of the AI model 360 for Γ_{S}.

RT20(B_{G}(Γ_{S}), c) may be determined by Equation 13 when a time point at which the energy decay value of sub-band c decreases below 0 decibel (dB) is t₁ and a time point at which the energy decay value of sub-band c decreases below −20 dB is t₂ in a sub-band-specific energy decay curve for the ground truth BIR. RT20_{sub} may be an estimate of the time required for the reverberation of sub-band c to decay by 60 dB, based on a 20 dB decay.

$$RT {20}_{sub} = 3 \times ( {t}_{2} - {t}_{1} ) \qquad [ Equation 13 ]$$

RT20(B_{N}(Γ_{S}), c) may be determined by Equation 13 when a time point at which the energy decay value of sub-band c decreases below 0 dB is t₁ and a time point at which the energy decay value of sub-band c decreases below −20 dB is t₂ in a sub-band-specific energy decay curve for the BIR output by the AI model 360.

Hereinafter, a method of generating a ground truth BIR for training the AI model 360 is described.

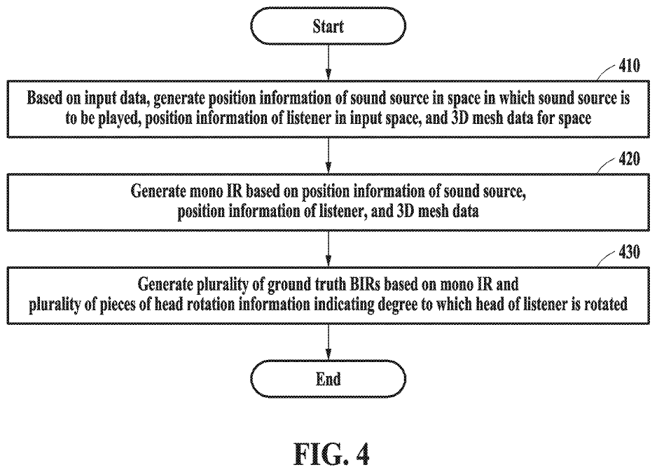

FIG. 4 is a flowchart illustrating an operation of an electronic device according to an embodiment.

Operations described with reference to FIG. 4 may be performed sequentially but not necessarily. For example, the order of the operations may be changed, and at least two of the operations may be performed in parallel.

In operation 410, based on input data, an electronic device may generate first position information of a sound source in a virtual space in which the sound source is to be played, second position information of a listener in the virtual space, and 3D mesh data for the virtual space.

The first position information, the second position information, and the 3D mesh data are described above with reference to FIG. 3, so any detailed description related thereto is omitted.

In operation 420, the electronic device may generate a mono IR based on the first position information of the sound source, the second position information of the listener, and the 3D mesh data.

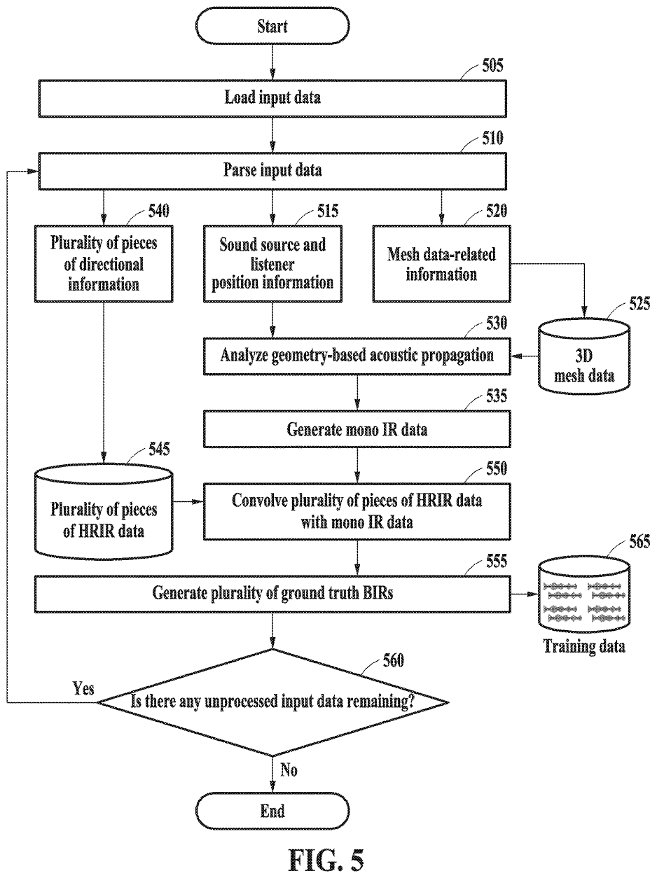

A method of generating a mono IR is described below with reference to FIG. 5.

In operation 430, the electronic device may generate a plurality of ground truth BIRs, based on the mono IR and a plurality of pieces of directional information indicating directional information of the sound source based on the head position of the listener.

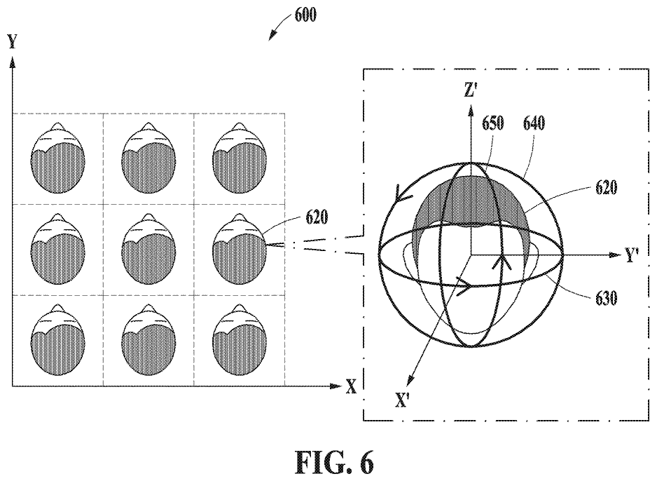

A method of generating a plurality of pieces of head rotation information is described below with reference to FIG. 6. A method of generating a plurality of ground truth BIRs is described below with reference to FIG. 5.

Hereinafter, a method of generating training data including a plurality of ground truth BIRs is described.

FIG. 5 is a block diagram illustrating generation of training data for training an AI model, according to an embodiment.

In block 505, an electronic device may load input data. The electronic device may load the input data from memory to generate training data for training an AI model. The input data may include sound source and listener position information 515 in a reference virtual space, mesh data-related information 520 in the reference virtual space, and a plurality of pieces of directional information 540. A plurality of pieces of directional information is described below with reference to FIG. 6.

In block 510, the electronic device may parse the input data.

The electronic device may obtain the sound source and listener position information 515 in the reference virtual space, the mesh data-related information 520 in the reference virtual space, and the plurality of pieces of directional information 540 by parsing the input data. The sound source and listener position information 515 may include first position information of the sound source and second position information of the listener. The electronic device may generate 3D mesh data 525 based on the mesh data-related information 520. Based on the plurality of pieces of directional information 540, the electronic device may generate a plurality of pieces of head related impulse response (HRIR) data 545 that reflects the plurality of pieces of directional information 540. HRIR data may be an IR that reflects the characteristics of sound reflection and/or diffraction by the body of the listener.

In block 530, the electronic device may perform geometry-based acoustic propagation analysis based on the sound source and listener position information 515 and the 3D mesh data 525. The electronic device may generate a mono IR 535 through geometry-based acoustic propagation analysis. The mono IR 535 may be a single channel IR.

In block 550, the electronic device may convolve the plurality of pieces of HRIR data 545 with the mono IR 535 to generate a plurality of ground truth BIRs 555 including left and right channels.

In block 560, the electronic device may determine whether there is unprocessed input data. The electronic device may terminate an operation if there is no unprocessed input data. The electronic device may perform block 505 if there is unprocessed input data.

The electronic device may generate a plurality of pieces of training data 565 including the plurality of ground truth BIRs 555, the plurality of pieces of directional information 540, the sound source and listener position information 515, and the 3D mesh data 525.

The electronic device may train an AI model based on the plurality of pieces of training data 565. Based on the plurality of pieces of training data 565, the electronic device may train the AI model to output a target BIR when the AI model receives a target mesh latent vector for a target virtual space in which a target sound source is to be played, a target position of a target listener, a target position of the target sound source, and target directional information of the target sound source based on the head position of the target listener.

FIG. 6 is a diagram illustrating generation of a plurality of pieces of head rotation information, according to an embodiment.

Referring to FIG. 6, a method of generating directional information of a sound source based on the head position of a listener. An electronic device may divide a virtual space 600 into a plurality of grid spaces. The virtual space 600 may be a virtual space that is a target of training.

For example, the electronic device may divide the virtual space 600 into grid spaces having a unit size of 1 meter (m). Herein, for ease of description, only the x-axis and the y-axis as viewed from the z-axis direction of the virtual space 600 are illustrated.

The electronic device may assume that a listener 620 is positioned in each grid. The electronic device may determine a plurality of pieces of head rotation information for the listener 620 positioned in each grid.

According to an embodiment, the electronic device may determine N angles by dividing each of a first trajectory 630 corresponding to the yaw axis, a second trajectory 640 corresponding to the roll axis, and a third trajectory 650 corresponding to the pitch axis into N equal parts. N may be a natural number. For example, when N is 36, the electronic device may determine a total of 36 angles including 10 degrees, 20 degrees, 30 degrees, 40 degrees, . . . , 350 degrees, and 360 degrees.

The electronic device may determine one rotation angle (e.g., yaw (φ), pitch (ϑ), roll (ρ)) around three axes (e.g., 3 DoF) describing head rotation in a 3D space by randomly determining one angle for each of the first trajectory 630 that is divided into equal parts, the second trajectory 640 that is divided into equal parts, and the third trajectory 650 that is divided into equal parts. The electronic device may determine head rotation information R_{yaw}, R_{pitch}, Rᵣₒₗₗ, based on the determined yaw (φ), pitch (ϑ), roll (ρ), yaw (φ), pitch (ϑ), roll (ρ) A method of determining R_{yaw}, R_{pitch}, Rᵣₒₗₗ is described above in detail with reference to FIG. 3, so any and detailed description related thereto is omitted.

The electronic device may determine the plurality of pieces of head rotation information by determining an angle multiple times (e.g., K times).

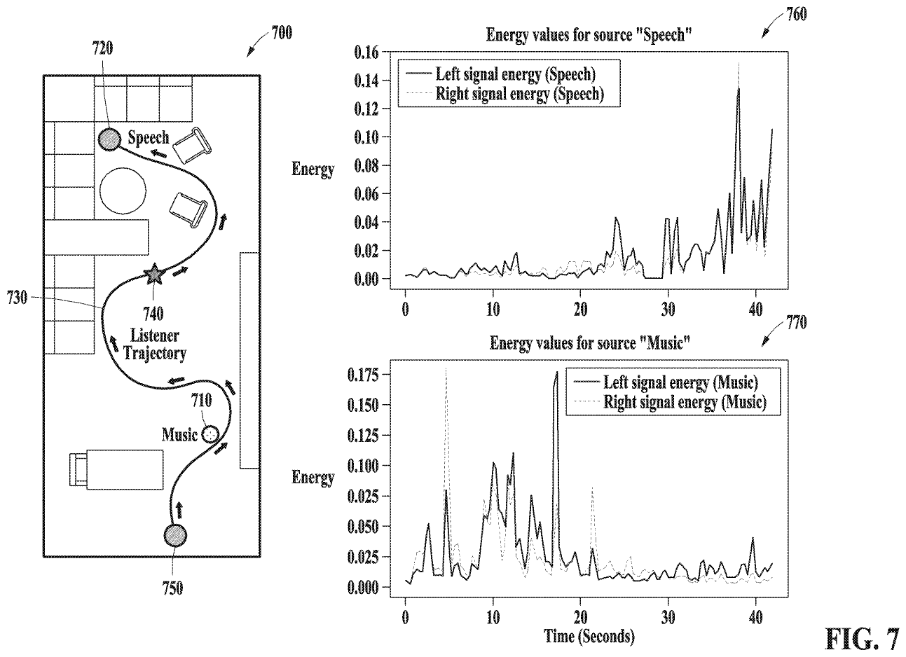

FIG. 7 is a diagram illustrating spatial audio according to an embodiment.

FIG. 7 illustrates a result of generating binaural spatial audio for a virtual space 700 that is not used for training, using an AI model trained by the method described above. Referring to the virtual space 700, two sound sources may be included. For example, a first sound source (e.g., music) may be played at a point 710, and a second sound source (e.g., speech) may be generated at a point 720.

A listener may start at a point 750 and move along a trajectory 730. The arrows displayed alongside the trajectory 730 may indicate the movement direction and position of the listener displayed every five seconds. For example, the arrow next to the point 710 may indicate that five seconds elapse since the listener departs from the point 750 and may show the movement direction of the listener.

A graph 760 and a graph 770 may each represent an energy curve for acoustic signals heard by the left and right ears of the listener as the listener moves, for each sound source. For example, the graph 760 may represent an energy curve for acoustic signals heard by the left and right ears of the listener for the second sound source generated at the point 720 as the listener moves. For example, the graph 770 may represent an energy curve for acoustic signals heard by the left and right ears of the listener for the first sound source generated at the point 710 as the listener moves.

The graph 760 and the graph 770 show that the energy decay properties resulting from the distances between the sound sources and the listener, as well as the ILD properties reflecting changes in sound level according to the relative positions of the sound sources and the left and right ears of the listener, are accurately reproduced.

For example, referring to the 25-second point (e.g., the listener is positioned at a point 740), the left ear of the listener faces the second sound source, while the right ear of the listener faces the first sound source. The graph 760 shows that the energy curve of an acoustic signal at the left ear is higher than the energy curve of an acoustic signal at the right ear.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor may receive instructions and data from read-only memory (ROM) or RAM, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk ROM (CD-ROM) or digital video disks (DVDs), magneto-optical media such as floptical disks, ROM, RAM, flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described herein in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multitasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed herein and the drawings are intended merely to present specific examples in order to aid in understanding of the present disclosure, but are not intended to limit the scope of the present disclosure. It will be apparent to one of one of ordinary skill in the art that various modifications based on the technical spirit of the present disclosure, as well as the disclosed embodiments, can be made.

What is claimed is:

1. An operation method of an electronic device, the operation method comprising:
generating a mesh latent vector based on three-dimensional (3D) mesh data for a virtual space that provides spatial audio to a listener;
inputting, to an artificial intelligence (AI) model, the mesh latent vector and conditional information comprising directional information of a sound source based on a head position of the listener; and
generating the spatial audio based on a binaural impulse response (BIR) obtained from the AI model.

2. The operation method of claim 1, wherein the conditional information comprises first position information of the sound source in the virtual space and second position information of the listener in the virtual space, and the directional information comprises azimuth information of the sound source based on the head position of the listener and elevation angle information of the sound source based on the head position of the listener.

3. The operation method of claim 1, wherein the AI model is trained to output the BIR reflecting an effect in which a sound level heard by a left ear and a right ear varies according to a change in a direction in which a head of the listener is oriented.

4. The operation method of claim 1, further comprising:
generating the directional information of the sound source based on head rotation information representing a degree of rotation of a head of the listener.

5. The operation method of claim 4, wherein the generating of the directional information comprises:
determining a rotation matrix based on the head rotation information;
determining position coordinates of the sound source with a position of the listener as an origin; and
determining the directional information based on the rotation matrix and the position coordinates.

6. The operation method of claim 1, further comprising:
determining the directional information based on third position information of a point viewed by the listener.

7. The operation method of claim 6, wherein the determining of the directional information based on the third position information comprises:
determining a unit vector from the listener toward the point based on first position information of the listener included in the conditional information and the third position information;
based on the unit vector, resetting a reference coordinate system to a coordinate system in which the listener views the point;
transforming second position information of the sound source based on the coordinate system; and
determining the directional information based on the transformed second position information.

8. A non-transitory computer-readable storage medium storing one or more computer programs comprising instructions that, when executed by a processor, cause the processor to perform the operation method of any one of claim 1.

9. An operation method of an electronic device, the operation method comprising:
based on input data, generating first position information of a sound source in a virtual space in which the sound source is to be played, second position information of a listener in the virtual space, and three-dimensional (3D) mesh data for the virtual space;
generating a mono impulse response (IR) based on the first position information of the sound source, the second position information of the listener, and the 3D mesh data; and
generating a plurality of ground-truth binaural IR (BIRs), based on the mono IR and a plurality of pieces of directional information representing directional information of the sound source based on a head position of the listener.

10. The operation method of claim 9, further comprising:
based on the plurality of ground-truth BIRs, training an artificial intelligence (AI) model to output a target BIR when the AI model receives a target mesh latent vector of a target virtual space in which a target sound source is to be played, a target position of a target listener, a target position of the target sound source, and target directional information of the target sound source based on a head position of the target listener.

11. The operation method of claim 10, wherein
the AI model is trained to minimize a loss function comprising a first loss related to quality of an output of the AI model, a second loss related to a relative change between a channel corresponding to a left ear and a channel corresponding to a right ear in the output a third loss related to energy decay and a fourth loss related to a reverberation time required for reverberation of a sub-band to decay by a predetermined number of decibels, and
wherein the first loss, the second loss, the third loss, and the fourth loss are determined based on the target BIR and the plurality of ground-truth BIRs.

12. An electronic device comprising a processor configured to generate a mesh latent vector based on three-dimensional (3D) mesh data for a virtual space that provides spatial audio to a listener, input, to an artificial intelligence (AI) model, the mesh latent vector and conditional information comprising directional information of a sound source based on a head position of the listener, and generate the spatial audio based on a binaural impulse response (BIR) obtained from the AI model.

13. The electronic device of claim 12, wherein the conditional information comprises first position information of the sound source in the virtual space and second position information of the listener in the virtual space, and the directional information comprises azimuth information of the sound source based on the head position of the listener and elevation angle information of the sound source based on the head position of the listener.

14. The electronic device of claim 12, wherein the AI model is trained to output the BIR reflecting an effect in which a sound level heard by a left ear and a right ear varies according to a change in a direction in which a head of the listener is oriented.

15. The electronic device of claim 12, wherein the processor is configured to generate the directional information of the sound source based on head rotation information representing a degree of rotation of a head of the listener.

16. The electronic device of claim 15, wherein the processor is configured to determine a rotation matrix based on the head rotation information, determine position coordinates of the sound source with a position of the listener as an origin, and determine the directional information based on the rotation matrix and the position coordinates.

17. The electronic device of claim 12, wherein the processor is configured to determine the directional information based on third position information of a point viewed by the listener.

18. The electronic device of claim 17, wherein the processor is configured to determine a unit vector from the listener toward the point based on first position information of the listener comprised in the conditional information and the third position information, reset, based on the unit vector, a reference coordinate system to a coordinate system in which the listener views the point, transform second position information of the sound source based on the coordinate system, and determine the directional information based on the transformed second position information.
